(19) United States
(12) Patent Application Publication
(10) Pub. No.: US 2008/0118298 A1
(43) Pub. Date: May 22, 2008

(54) NAIL VARNISH APPLICATOR

(76) Inventor: Shara Louise MARZUOLI, Bedfordshire (GB)

Correspondence Address: HESLIN ROTHENBERG FARLEY & MESITI PC, 5 COLUMBIA CIRCLE, ALBANY, NY, 12203, US

(21) Appl. No.: 11/943,640

(22) Filed: Nov. 21, 2007

(30) Foreign Application Priority Data
Nov. 22, 2006 (GB) GB0623246.6

(51) Int. Cl. B43M 11/06; A45D 44/00; A46D 1/00

(52) U.S. Cl. 401/185; 132/200; 15/207.2

(57) ABSTRACT

An applicator for nail varnish comprises a reservoir, a brush made up of a plurality of bristles, a passage or opening connected to the reservoir, and a compressible suction bulb which is used to draw liquid nail varnish into the reservoir through the passage or opening and to deliver it back to the brush for subsequent application to a nail. The applicator may incorporate a screw threaded cap, such that the combination is adapted to seal a neck of a container for nail varnish. Compressing and releasing the bulb with a substantial part of the brush immersed in the container draws nail varnish into the reservoir which can then be applied to several nails without requiring refilling.

### CROSS REFERENCE TO RELATED APPLICATIONS

This application claims priority from UK patent application No. GB 0623246.6, filed on Nov. 22, 2006, the entire disclosure of which is incorporated herein by reference.

The present invention relates to an applicator for liquid compositions applied by means of a brush, such as nail varnish and the like. More particularly but not exclusively, it relates to an applicator having a reservoir for the liquid composition, to a container for the liquid composition provided with said applicator, and to a method for applying said composition.

Nail varnish is normally applied using a short generally cylindrical brush mounted at a distal end of an elongate stem, held at a proximal end by the user. The brush is dipped into a jar or vial of nail varnish to pick up a charge of liquid varnish, which is then, painted on to a finger or toe nail.

Nail varnish conventionally contains highly volatile solvents so that it dries rapidly after application to form a hard, glossy film on the nail. Unfortunately, this results in the varnish tending to dry out on the brush, clogging its bristles. Thus, when the charge of liquid varnish is used up, and the user returns the brush to the container to refresh it, there is a risk that some bristles will have become stuck together and/or become contaminated with dried blobs of varnish, which may not redissolve in the fresh charge of liquid varnish. This can lead to an unattractive lumpy or streaky finish on subsequently-coated nails.

Furthermore, if a charge of liquid varnish runs out part-way through painting a nail, there is a risk that a “tide-mark” may be formed, when painting the nail is completed using a fresh charge of varnish.

A conventional brush sufficiently large to hold enough liquid varnish to complete a set of nails in a single operation would probably either be too broad for accurate application, or too long in the bristle, in which case varnish may dry out near the bristles' roots, and the brush may not be sufficiently controllable.

Conventionally, each charge of varnish will be enough for no more than one nail. This necessitates frequent dipping of the brush into the container, which is inconvenient and may risk upsetting the container. There is hence a need for an applicator for nail varnish which can hold sufficient varnish to coat several nails in sequence without drying out.

Similar problems may be experienced with other liquid compositions containing volatile solvents, such as conventional varnishes and paints, and obliterating or correcting fluids. In the latter case in particular, applicator brushes are notorious for becoming clogged with dry white deposits which are inconvenient to remove. Thus, while the present invention will largely be described with respect to the application of nail varnish, it is equally applicable to other liquid compositions having premature drying problems, and the term nail varnish herein should be interpreted accordingly.

It is hence an object of the present invention to provide an applicator for nail varnish or the like which obviates the above problems and allows smooth, substantially blemish-free application of the varnish. It is also an object of the present invention to provide a container for nail varnish or the like comprising such an applicator, and a method for applying nail varnish therewith.

According to a first aspect of the present invention, there is provided an applicator for nail varnish as herein defined, comprising reservoir means, brush means, passage means extending adjacent said brush means and connected to the reservoir means, and suction means manually operable to draw liquid nail varnish into the reservoir means through the passage means and to deliver it back to the brush means for subsequent application to a substrate such as a nail.

Preferably, the passage means extends adjacent root means of the brush means.

Advantageously, the passage means comprises delivery aperture means adjacent the root means of the brush means.

The applicator means preferably comprises recess means adjacent the root means of the brush means, into which nail varnish is deliverable from the passage means.

The brush means may then define one face of said recess means.

Preferably, the brush means comprises a plurality of generally parallelly extending elongate bristle means arranged in a curve, a concave face of said curve being aligned towards the passage means or the delivery aperture means thereof.

Advantageously, said bristle means are rooted generally in an arc of a circle centred on the delivery aperture means of the passage means.

In an alternative embodiment, the brush means comprises a plurality of generally parallelly extending elongate bristle means defining a hollow shape surrounding the passage means.

Advantageously, the bristle means are then arranged in a hollow cylinder around the passage means.

The brush means may comprise mounting means to which die bristle means are attached and through which the passage means also extends.

In each embodiment, the reservoir means is preferably at least partially transparent or translucent so as to make visible a level of nail varnish contained therein.

Advantageously, the reservoir means comprises a substantially rigid elongate tubular vessel.

Said elongate vessel may be aligned substantially parallelly to the bristle means.

Preferably, the suction means comprises bulb means compressable manually, for example between thumb and finger of a hand of a user.

The suction means may be connected directly to the reservoir means.

Alternatively, the suction means may connected to the reservoir means through flexible connector means.

The suction means may comprise handle means for the applicator.

Preferably, the suction means is provided with protective enclosure means.

Advantageously, said protective enclosure means comprises rigid shell means provided with window means adapted for the suction means to be squeezed therethrough, optionally digitally.

In a preferred embodiment, the applicator may comprise closure means adapted selectably to seal an opening of a container for nail varnish.

Advantageously, said closure means comprises cap means so threaded as to be engageable with a corresponding thread adjacent the opening of the container.

The brush means of the applicator may be disposed within said container when the closure means is in position sealing said opening, and the suction means may then be disposed externally of the container.

The reservoir means may then extend through the closure means.

According to a second aspect of the present invention, there is provided a container for nail varnish as herein defined, comprising an applicator as described in the first aspect above, adapted to seal removably an opening of the container.

Preferably, said applicator is provided with threaded cap means, engageable with corresponding thread means adjacent the opening of the container.

Advantageously, the applicator is adapted to seal the opening with its brush means disposed within the container and its suction means disposed externally thereof.

The reservoir means may then extend through the cap means.

According to a third aspect of the present invention, there is provided a method of applying nail varnish to a nail, comprising the steps of providing an applicator as described in the first aspect above, operating the suction means thereof so as to draw nail varnish into the reservoir means thereof, applying the brush means thereof to a nail to be varnished, and operating the suction means so as to deliver nail varnish to the brush means.

Preferably, the nail varnish is delivered to the brush means as the brush means is drawn across a surface of the nail.

Advantageously, the method comprises the step of providing a container of liquid nail varnish comprising an applicator, as described in the second aspect above.

The method may comprise the steps of applying nail varnish sequentially to a plurality of nails without repeating the step of drawing nail varnish into the reservoir means.

Embodiments of the present invention will now be more particularly described by way of example and with reference to the accompanying drawings, in which:

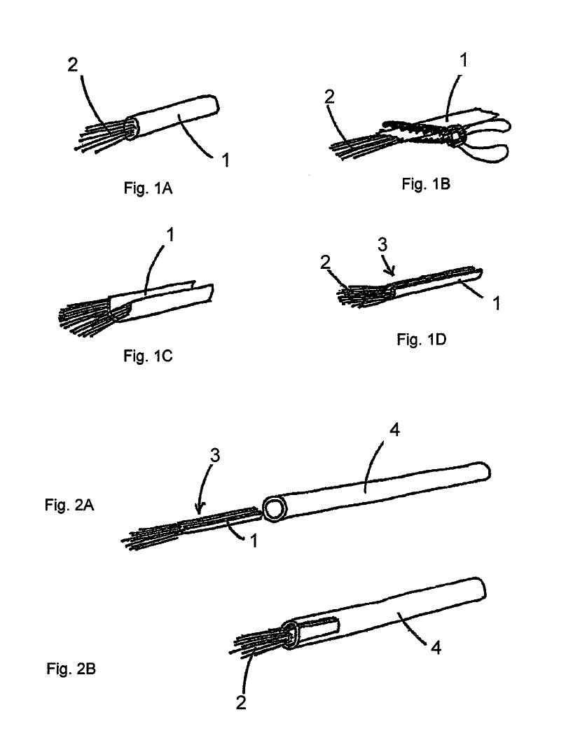

FIGS. 1A to 1D are perspective views showing stages of production of a brush element for an applicator embodying the present invention;

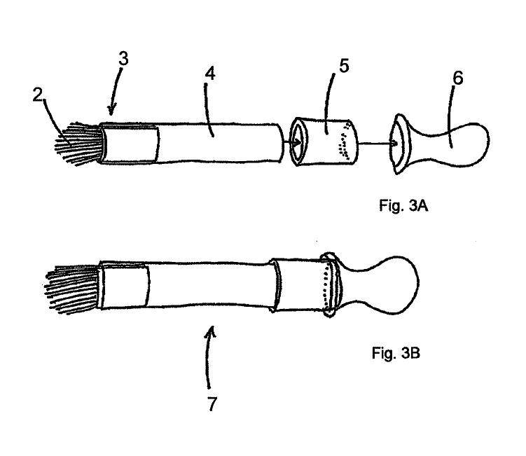

FIGS. 2A and 2B are perspective views showing mounting of the brush element shown in FIG. 1D to a reservoir tube of an applicator embodying the present invention;

FIGS. 3A and 3B are perspective views showing assembly of a first applicator embodying the present invention;

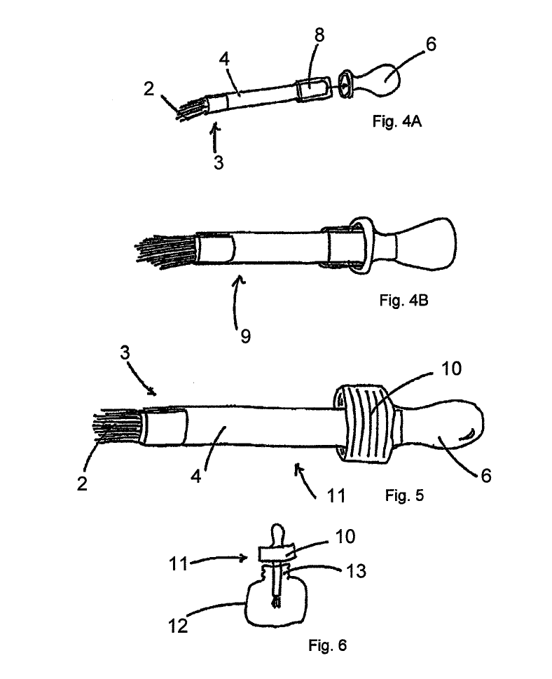

FIGS. 4A and 4B are perspective views showing assembly of a second applicator embodying the present invention;

FIG. 5 is a perspective view of a third applicator embodying the present invention;

FIG. 6 is a schematic elevation of a container for nail varnish provided with an applicator as shown in FIG. 5;

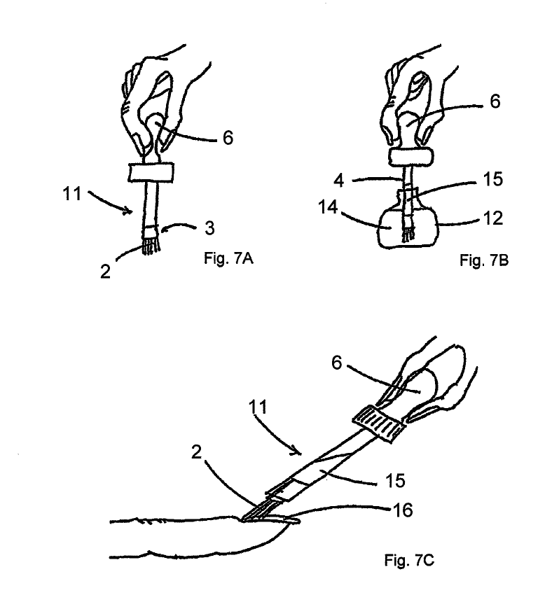

FIGS. 7A to 7C are schematic elevations showing application of varnish to a nail, using the applicator shown in FIG. 5;

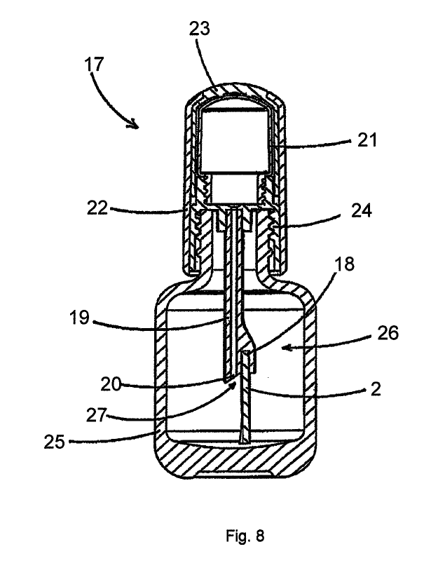

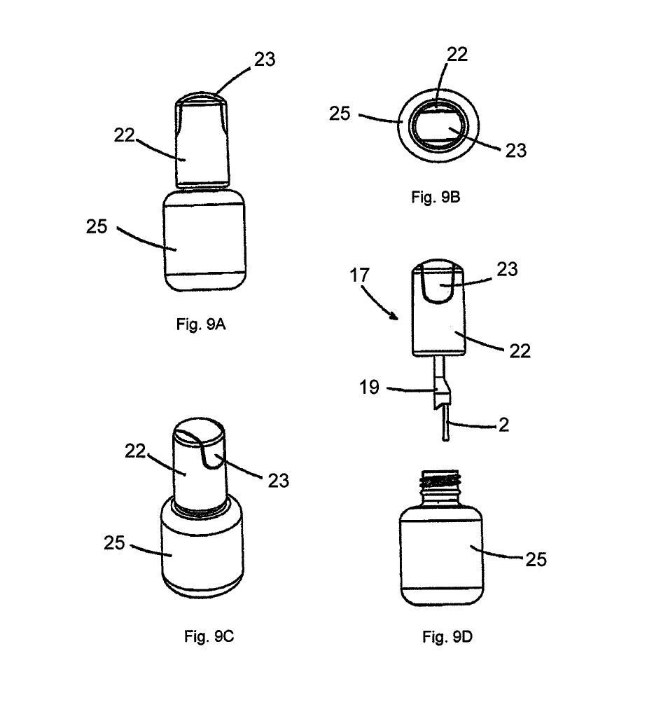

FIG. 8 is a cross-sectional elevation of a fourth applicator embodying the present invention, in place in a respective container for nail varnish;

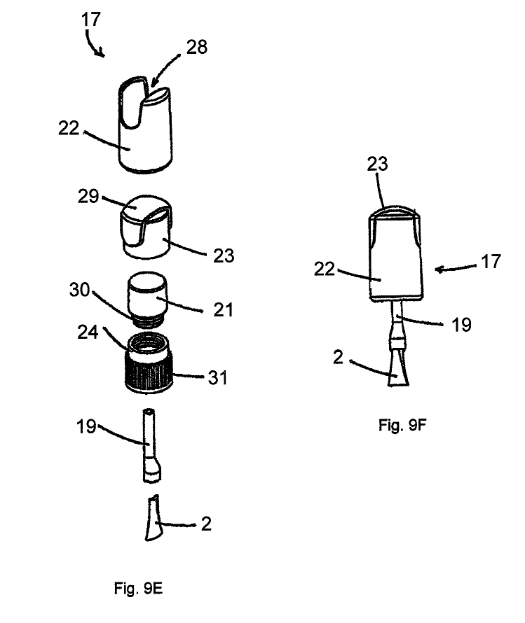

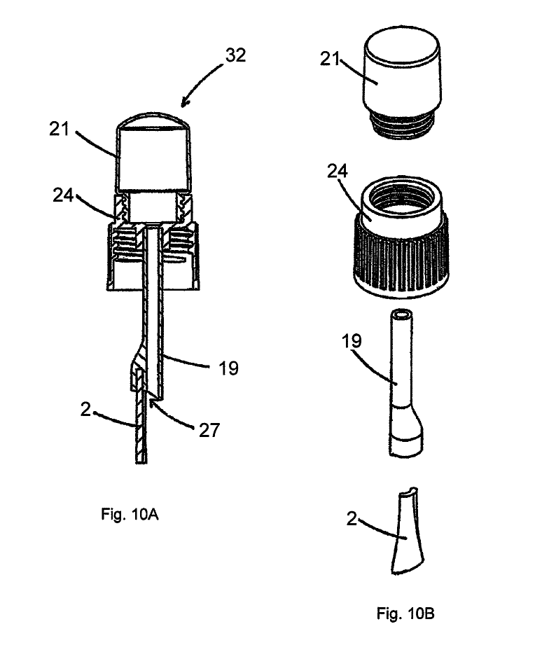

FIG. 9A to 9C are a frontal elevation, a plan view from above and a perspective view, respectively, of the fourth applicator and container as shown in FIG. 8;

FIG. 9D is a side elevation of the fourth applicator as shown in FIG. 8, withdrawn from the container;

FIG. 9E is an exploded perspective view of the fourth applicator as shown in FIG. 8;

FIG. 9F is a frontal elevation of the fourth applicator as shown in FIG. 8;

FIG. 10A is a cross-sectional elevation of a fifth applicator embodying the present invention; and

FIG. 10B is an exploded perspective view of the fifth applicator shown in FIG. 10A.

Turning now to the figures, and to FIG. 1A in particular, an elongate tube 1 of thin, malleable aluminium or the like has a plurality of natural or synthetic bristles 2 inserted into an open end thereof so as to project therefrom generally parallelly to a longitudinal axis of the tube 1. The tube 1 is then crimped flat, as shown in FIG. 1B, holding the bristles 2 securely in place as a generally planar brush. The flattened tube 1 is next curled around an axis parallel to the bristles 2 (as shown in FIG. 1C), for example by being formed around a cylindrical mandrel. Ultimately, the flattened tube 1 is rolled into a cylinder, as shown in FIG. 1D, to produce a hollow brush element 3. The brush element 3 thus comprises a plurality of bristles 2 arranged in the form of a hollow cylinder, a central bore of which is linked to a bore extending from end to end of the rolled tube 1.

The brush element 3 is inserted into an open end of an elongate reservoir tube 4 as shown in FIG. 2A. The reservoir tube 4 comprises a clear plastics material, or optionally glass, to allow viewing of its contents. The rolled tube 1 of the brush element 3 may be a friction fit within a bore of the reservoir tube 4, or may be sealed in place with adhesive. As shown in FIG. 2B, the bristles 2 thus project from the reservoir tube 4 generally parallelly to a longitudinal axis thereof, and the bores of the brush element 3 and the reservoir tube 4 are linked.

In a first applicator 7, as shown in FIGS. 3A and 3B, a first end of a clear flexible plastics connector tube 5 is mounted to an end of the reservoir tube 4 remote from the brush element 3, and a squeezable bulb 6, typically of latex rubber or other elastomer, is mounted to a second end of the connector tube 5 remote from the first. The connector tube 5 is glued sealingly to the reservoir tube 4, and the bulb 6 is glued sealingly to the connector tube 5. Thus, if the bulb 6 is squeezed and released, fluid may flow in and out of an interior of the first applicator 7 only through the brush element 3.

In a second applicator 9, as shown in FIGS. 4A and 4B, the end of the reservoir tube 4 remote from the brush element 3 is surrounded by a sleeve 8. The squeezable bulb 6 is then mounted around both the sleeve 8 and the respective end of the reservoir tube 4 and is glued sealingly in place.

A third applicator 11, shown in FIG. 5, is generally similar to the second applicator 9, with the addition of a generally cylindrical hollow cap element 10 mounted to the sleeve 8 coaxially around the reservoir tube 4. The third applicator 11 is intended to form a closure for a jar 12 or other container of nail varnish, as shown in FIG. 6. The cap element 10 is provided with an internal thread engageable with, an externally-threaded neck 13 of the jar 12, so as to seal the jar 12.

To use the applicator 11, as shown in FIGS. 7A to 7C, the bulb 6 is squeezed between thumb and forefinger, expelling air from its interior through the bore between the bristles 2 of the brush element 3. The brush element 3 is then dipped into the jar 12 and submerged in a supply 14 of liquid nail varnish contained therein. The bulb 6 is slowly released, creating suction which draws liquid varnish up through the bore of the brush element 3 into the reservoir tube 4. Since the reservoir tube 4 is clear, the user may draw up a charge 15 of liquid varnish of a desired volume.

The bristles 2 of the applicator 11 are then brought into contact with a nail 16 to be varnished. The bulb 6 is squeezed gently to deliver liquid varnish 15 to the bristles 2, to replace that transferred to the nail 16 as the applicator 11 is stroked thereacross. The applicator 11 shown easily holds a sufficient charge 15 of the liquid varnish at least to coat each nail 16 on a hand or a foot in turn, before needing to be returned to the jar 12 to be refilled.

A continual flow of liquid varnish is maintained, out from the reservoir tube 4, through the bore of the brush element 3, and into the bore between the bristles 2, from whence it wicks into gaps between individual bristles 2, flows down the bristles 2 and is transferred to the nail 16 from the tips of the bristles 2. At no point is any liquid varnish left “stagnant” where it might dry out, so the bristles 2 will remain flexible and unclogged, producing an even, attractive coating on each nail 16. Even if slight drying were encountered, such as on a very warm day or with particularly volatile solvents, varnish could be “pumped” in and out of the applicator 11, through the bristles 2, to ensure that any partially solidified material redissolves.

As an alternative to the particular brush element 3 shown, it is also envisaged that the roots of the bristles 2 could be embedded in one annular end-face of a hollow cylindrical collar of plastics material.

While the applicators 7, 9, 11 are shown with no particular brush profile, clearly the bristles 2 could all be made the same length, to give a flat-ended brush element 3, or the brush element 3 could be provided with an obliquely angled tip, or more complex profiles, if desired.

Although the hollow cylindrical brush elements 3 are shown are probably the most generally useful shape, it is envisaged that other shapes could be produced, optimised for particular uses.

FIG. 8 shows a fourth applicator 17 embodying the present invention, having a (currently preferred) form which differs in several respects to that of the applicators 7, 9, 11 described above.

A plurality of nylon bristles 2 are inserted into a socket 18 formed in a first end of an elongate plastics tube 19, adjacent an opening 20 of the tube 19. The reservoir tube 19 is connected at a second end remote from the first to a compressible bulb 21. The bulb 21 is located within a rigid plastics cap element 22, which is provided with a resiliently deformable elastomer insert 23 (shown more clearly in FIGS. 9A to 9F) surrounding the bulb 21. Part of the insert 23 is accessible through a gap or window in the rigid element 22. The applicator 17 also comprises a thread element 24, which is engageable with a co-operating thread on a neck of a container 25. The applicator 17 thus acts as a sealing lid or cap for the container 25, with the bristles 2 and most of the reservoir tube 19 extending into an interior 26 of the container 25. The container 25 may hold nail varnish (or any other volatile material requiring controlled application to a surface, such as correction fluid).

In use, the insert 23 is squeezed and released, compressing and releasing the bulb 21. As in the case of the applicators 7, 9, 11 above, this draws a charge of nail varnish or the like from the interior 26 of the container 25 into the reservoir tube 19.

The applicator 17 is then unscrewed from the container 25, and the bristles 2 are applied to a nail to be varnished. The insert 23 is gently squeezed, compressing the bulb 21 slightly and displacing varnish out of the opening 20 of the reservoir tube 19. Since the opening 20 is adjacent the roots of the bristles 2, the varnish will flow on to and between the bristles 2 towards their tips.

The first end of the tube 19 around the opening 20 has an angled profile, as shown, which defines a notch 27 between the first end of the tube 19 and the roots of the bristles 2. Varnish displaced out of the opening 20 will tend to collect in the notch 27, ensuring that it contacts the roots of the bristles 2 as intended. It will then be drawn along the bristles 2 by capillary forces.

Thus, when the bristles 2 are drawn along the nail, varnish on the bristles 2 will be laid down as an even layer and continually replaced, as long as the user squeezes the insert 23 sufficiently to deliver fresh varnish into the notch 27. The reservoir tube 19 shown can hold sufficient varnish for several nails to be treated using a single charge, before the applicator 17 need be returned to the container 25 to be refilled.

FIGS. 9A to 9F show various features of the fourth applicator 17 more clearly. FIGS. 9A to 9D show a preferred configuration of the rigid cap clement 22 and the deformable insert 23. The rigid cap element 22 has a gap or window extending across its top and part-way down opposite sides, which allows fingertip access to the deformable insert 23 within. This configuration permits a user to squeeze the insert 23 (and hence the enclosed bulb 21) controllably between fingertip and thumbtip, for example. Meanwhile, the configuration of the remainder of the rigid cap element 22 protects the insert 23 and bulb 21 from being crushed or squeezed accidentally (e.g. if dropped).

The exploded view of the applicator 17 in FIG. 9E shows this window 28 in the cap element 22 more clearly. Preferably, the insert 23 has an expanded portion 29 having a shape corresponding to that of the window 28. This locates the insert 23 positively within the cap element 22, and produces a substantially smooth and continuous profile for the outside of the applicator 17.

Other structural features visible in FIG. 9E include a threaded portion 30 of the bulb 21, by which it is connected to the threaded element 24 (the threaded element 24 thus has a thread to receive the bulb 21 and a thread, not visible in FIG. 9E, to engage with the threaded neck of the container 25). In this embodiment, the threaded element 24 is also provided with a plurality of external longitudinal ribs 31, which help it to grip an inner face of the cap element 22 when the applicator 17 is assembled. The reservoir tube 19 is in this embodiment press-fitted into a corresponding socket in the threaded element 24 (compare FIGS. 9A and FIG. 8).

Comparison of FIGS. 9D, 9E and 9F also shows the preferred configuration of the bristles 2. The socket 18 (FIG. 8) is arcuate, generally concentrically with the opening 20 of the reservoir tube 19. The roots of the bristles 2 thus form an arc partially encircling the opening 20 and further enclosing the notch 27 formed between the first end of the reservoir tube 19 and the roots of the bristles 2. The bristles 2 splay slightly outwardly towards their tips, which form a broader but shallower arc than their roots. The tips of the bristles 2 are thus configured to conform generally to a profile of a finger or toe-nail, further improving the ease and effectiveness of application of the varnish.

A fifth, simplified applicator 32 is shown in FIGS. 10A and 10B. This does not have the rigid cap clement 22 and resiliently deformable insert 23, leaving the bulb 21 exposed. There may well be applications in which the risk of accidental squeezing or damage to the bulb 21 is outweighed by the greater simplicity of this form of the applicator 32. The other difference between the fourth and fifth applicators 17, 32 is that the fifth applicator 32 has a reservoir tube 19 with a wider bore. This appears to be a design choice that can be made based on the volume of the charge of fluid required to be held in the reservoir tube 19, the viscosity of the fluid, and so forth. The reservoir tube 19 of the fifth applicator 32 is still so profiled that there is a notch 27 between its end and the roots of the bristles 2, into which nail varnish or other fluid is delivered from the tube 19.

As mentioned above, while the applicators 7, 9, 11, 17, 32 described are optimised for applying nail varnish, it is envisaged that applicators embodying the present invention might also be useful for applying other compositions containing volatile solvents, such as correcting fluid.

1. An applicator for nail varnish comprising reservoir means, brush means, passage means extending adjacent said brush means and connected to the reservoir means, and suction means manually operable to draw liquid nail varnish into the reservoir means through the passage means and to deliver it back to the brush means for subsequent application to a substrate such as a nail.

2. An applicator as claimed in claim 1, wherein the passage means extends adjacent root means of the brush means.

3. An applicator as claimed in claim 2, wherein the passage means comprises delivery aperture means adjacent said root means.

4. An applicator as claimed in claim 2, comprising recess means adjacent said root means into which nail varnish is deliverable from the passage means.

5. An applicator as claimed in claim 1, wherein the brush means comprises a plurality of generally parallelly extending elongate bristle means arranged in a curve, a concave face of said curve being aligned towards the passage means.

6. An applicator as claimed in claim 1, wherein the brush means comprises a plurality of generally parallelly extending elongate bristle means defining a hollow shape surrounding the passage means.

7. An applicator as claimed in claim 1, wherein the reservoir means is adapted to make visible a level of nail varnish contained therein.

8. An applicator as claimed in claim 1, wherein the reservoir means comprises a substantially rigid elongate tubular vessel.

9. An applicator as claimed in claim 1, wherein the suction means comprises manually compressible bulb means.

10. An applicator as claimed in claim 1, wherein the suction means is provided with protective enclosure means.

11. An applicator as claimed in claim 1, wherein the applicator comprises closure means adapted selectably to seal an opening of a container for nail varnish.

12. An applicator as claimed in claim 11, wherein said closure means comprises cap means so threaded as to be engageable with a corresponding thread adjacent the opening of the container.

13. An applicator as claimed in claim 11, wherein the brush means is disposable within said container and the suction means is disposable externally of the container when the closure means is in position sealing said opening.

14. A container for nail varnish as herein defined, comprising an applicator having reservoir means, brush means, passage means extending adjacent said brush means and connected to the reservoir means, and suction means manually operable to draw liquid nail varnish into the reservoir means through the passage means and to deliver it back to the brush means for subsequent application to a substrate such as a nail, said applicator being adapted to seal removably an opening of the container.

15. A container as claimed in claim 14, wherein said applicator is provided with threaded cap means, engageable with corresponding thread means adjacent the opening of the container.

16. A method of applying nail varnish to a nail, comprising the steps of providing an applicator comprising reservoir means, brush means, passage means extending adjacent said brush means and connected to the reservoir means, and suction means manually operable to draw liquid nail varnish into the reservoir means through the passage means and to deliver it back to the brush means for subsequent application to a substrate such as a nail, operating the suction means thereof so as to draw nail varnish into the reservoir means thereof, applying the brush means thereof to a nail to be varnished, and operating the suction means so as to deliver nail varnish to the brush means.

17. A method as claimed in claim 16, comprising the step of providing a container of liquid nail varnish comprising said applicator.

18. A method as claimed in claim 16, comprising the steps of applying nail varnish sequentially to a plurality of nails without repeating tine step of drawing nail varnish into the reservoir means.
